(19) United States
(12) Patent Application Publication
(10) Pub. No.: US 2019/0172041 A1
(43) Pub. Date: Jun. 6, 2019

(54) METHODS AND APPARATUS FOR PROVIDING AN EASY RETURN, EXCHANGE AND PURCHASING EXPERIENCE IN A RETAIL STORE ENVIRONMENT

(71) Applicant: Tommy Lee Hill, Cedar city, UT (US)

(72) Inventor: Tommy Lee Hill, Cedar city, UT (US)

(21) Appl. No.: 16/267,672

(22) Filed: Feb. 5, 2019

Related U.S. Application Data
(60) Provisional application No. 62/636,148, filed on Feb. 27, 2018.

(51) Int. Cl. G06Q 20/20; G06Q 20/40; G06Q 20/18; G06Q 20/36

(52) U.S. Cl. CPC G06Q 20/208; G06Q 20/407; G06Q 20/3672; G06Q 20/18; G06Q 20/203; G06Q 20/202

(57) ABSTRACT

The present invention relates to a self-operating networked kiosk device for providing an easy return, exchange and purchasing experience in a retail store environment. The kiosk device includes a vision module communicably coupled to the computing device and at least one sensor, such that the vision module captures a raw data related to the said item via the at least one sensor, an object and character recognition (OCR) module configured to identify a primary data from the raw data based on at least one predefined parameter, wherein the AI module is configured to identifying at least one first block having a first fingerprint data related to the item, the first block stored on a networked distributed ledger and creating a second block including the first fingerprint data and the second fingerprint data on the networked distributed ledger.

### CROSS REFERENCE TO RELATED APPLICATION

This application claims the benefit of U.S. Provisional Application No. 62/636,148 filed on Feb. 27, 2018 which is incorporated by reference herein.

### FIELD OF DISCLOSURE

The present invention relates to vending machines and kiosk technology enabled with wireless telecommunication components for facilitating easy return and purchasing of items by using object and character recognition, artificial intelligence and block chain technology. More particularly, the present disclosure will include discussion of novel method and an apparatus for providing an easy return, exchange and purchasing experience in a retail store environment.

### BACKGROUND

Consumer-operated kiosks provide and implement technologies that allow customers to purchase, reload, rent, return and recycle various products, and to conduct a wide variety of transactions. Some exemplary kiosks include DVD rental kiosks; coin-counting kiosks; kiosks for dispensing and reloading prepaid cards (gift cards, phone cards, etc.); kiosks for exchanging gift cards for cash and or other gift cards; fresh food vending kiosks; coffee kiosks; consumer-electronics vending kiosks; kiosks for dispensing beauty products, other types of consumer products, and or product samples; kiosks for vending event, travel, and or other types of tickets; etc.

Electronic commerce is achieving widespread use. Transactions are performed every day over the Internet and through point of sale (POS) or bank systems. Such systems are designed to maintain the integrity of the user's credit card, debit card, and account number. However, no measures are taken to ensure the privacy of the user. As the vendor retains information regarding the identity of the user, the user is subject to receipt of marketing materials and other online material that may result from data mining of their transactions performed on various computer and internet networks.

A user's privacy is of particular concern with regard to the distribution of products. For example, there is a lack of intelligent and automatic technology which can function on behalf of a merchant to manage inventory and assets within and across boundaries (merchant-to-merchant, merchant-to-consumer, merchant-to-other supply chains). Also, there is a lack of a secure, policy-enabled, automated merchant-to-merchant inventory exchange model. Additionally, most traditional delivery mechanisms require the consumer to be home or present in order for delivery to occur, resulting in multiple re-delivery costs.

Numerous kiosks have been developed for dispensing products without the presence of a salesperson or vendor in a self-serve manner. These kiosks have tended to suffer from numerous problems, which have prevented their wide adoption. Previous kiosks have tended to have numerous moving parts, which tend to break, resulting in lost sales and requiring repair. They also have tended to be relatively large machines requiring a large footprint, which is not always available in potential kiosk locations and often requires that the kiosk occupy wall space. In addition, kiosks have tended to be stocked like vending machines, requiring each individual product to be added at the kiosk to the proper location in the kiosk to take the place of the dispensed product. Where the kiosk rents products, the individual products still have to be added (returned) to known kiosks to the proper location in the kiosk, either by the customer (requiring a complicated mechanism to return the product to the proper location), or by a technician (requiring a visit by this trained person).

A drawback in known return kiosks is that some customers with multiple products to be returned will try to insert more than one item at a time into the slot in hopes of more quickly returning the items. The return process is complex and time consuming. Certain of these customers may even try to force multiple items into the slot and thereby cause a jam in the slot. When the slot becomes jammed, a service call by field service personnel is usually required to clear the jam condition.

Further, with normal brick-and-mortar business merchandise returns, the merchant typically does not issue a refund or other return until a person intercedes and inspects the returned product to ensure it meets the merchant's requirements, including completeness of the returned item. For example, if a consumer returns a camcorder to an electronics outlet unless the battery is included, the consumer will not receive the full refund. However, with a virtual mode through the online portal, the same consumer may be returning the item by mail, and a dispute may arise. The merchant, in this case, will have either an unhappy customer or added expense from taking back an incomplete return. In addition, even if the return is perfect, the merchant is unlikely to have a system in place to handle the return, both within the merchant's facility and with respect to any outside suppliers.

Further, in some cases, the returned item came damaged and the person handling returns was not able to notice it due to oversight or the item returned has internal damage that is not traceable by human intervention. It cost to a seller or merchant.

In U.S. Pat. No. 2,017,029,391,6A1 Douglas Humphrys et. al, discloses systems, apparatuses, and methods provided for processing a merchandise return transaction. A system for processing a merchandise return transaction comprising: a user interface for allowing direct entry of information by a customer without assistance from a worker; a database; and a control circuit coupled to the user interface and the database, the control circuit configured to execute the return transaction by: obtaining from the customer identifier relating to a purchase transaction in which at least one item was previously purchased; identifying a product item from the purchase transaction to be returned; obtaining from the customer a reason for the product item to be returned; obtaining from the customer a preferred tender for the return transaction; authorizing the return; and providing instructions to the customer for returning the product item to a retail facility.

In another U.S. Pat. No. 674,493,8B1 Edward G. Rantze et. al discloses a system, method and apparatus for identifying a product through reading of the product label by a retail terminal. The product/product label is scanned by an imager of a retail terminal. An attribute recognition program such as an optical character recognition (OCR) program is used on the scanned product label which generates text strings from alphanumeric label information and graphics maps/images from graphics/logos. Text strings and/or graphics data are then compared to various text strings and graphics data in a database or look-up table to return information relative to the scanned text string(s)/graphic(s). In one form, kiosks, incorporating an imager and the necessary hardware and software to scan a product label and process the scanned information in accordance with the present principles, may provide printouts of product information, instructions, order forms or the like for the scanned product. Additionally, standard queries or user-generated queries may be answered relative to the scanned product label.

What is needed is a method and system that provide assistance to the business with the process of handling returned or exchange of goods with no wait time, from both the perspective of missing or fraudulent returns and the perspective of reduced and managed supply chain costs.

### SUMMARY OF THE DISCLOSURE

It should be understood that this disclosure is not limited to the particular systems, and methodologies described herein, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

The present invention is directed to provide a self-operating networked or wireless-enabled kiosk device for providing an easy return, exchange and purchasing experience in a retail store environment. The self-operating kiosk includes the following components: a touch screen having a user interface, an input unit, one or more processors, a communication unit which is adapted to communicate with remote server, remote database, and other devices via wireless communication such as internet, one or more sensors for capturing raw data, a distributed ledger or a block chain database, remote server having a remote database or an inventory database, a memory unit that stored executing instructions, a receptacle having a receiving area on the top of a receptacle for receiving the item, a hollow enclosure within the receptacle for receiving the returned product. The self-operating s kiosk device may include other components such as a backup power supply. The computing power may be local or remote as part of a kiosk network. A plurality of devices and a central computer/server may form a network of devices. The self-operating kiosk is adapted to process the item whether it's a return product or newly purchased product at the kiosk and store all processes in the local memory of the kiosk and/or a remote database via central computer/server. The self-operating kiosk is adapted to create a fingerprint of data from the input data by using the vision module, object and character recognition module and artificial intelligence module. The vision module captures a raw data related to the said item via the at least one sensor based on the at least one action and stores the raw data in a memory, an object recognition module and optical character recognition (OCR) modules configured to identify a primary data from the raw data based on at least one predefined parameter and store the primary data in the memory. The self-operating kiosk is adapted to stores the fingerprint data of the customer on a distributed ledger or block chain.

In one aspect of the present invention, a self-operating kiosk device includes a detachable conveyor belt system attached to a receptacle unit for transferring the purchased or exchanged/returned item from automated inventory or a manual inventory to the kiosk and vice versa.

In an exemplary use, the self-operating kiosk device facilitates the purchase of at least one item. The purchasing is done at the kiosk by a user via using the touch screen user interface. The purchasing item information e.g. date of purchase, product details, and billing information etc. is transferred from the automated inventory or manual inventory to the kiosk upon successful transaction. The automated inventory selects the purchased item from the automated inventory warehouse or the automated retail store and put the purchased onto the conveyor belt system. The conveyor belt system transfers the purchased item to the receptacle of the kiosk, where the user can pick a product and checkout the retail store. The kiosk allows the user to permit a user to deposit traditional currency (e.g., United States dollars) for cash payment or user and opt different type of payment option such credit/debit card, NFC payment, internet backing, mobile banking and the like.

In an exemplary use, the self-operating kiosk device facilitates the return of the purchased item at the kiosk in a very easy and efficient manner. A first stage comprises: (i) User provide the item return request to the kiosk via touch screen user interface; (ii) Based on the request, user is prompted to place the item and the receipt of the item if available on the receiving area of the item receiving unit; (iii) the sensor attached to the item receiving unit detects the presence of the item and trigger the processing of the item via vision module. All sensors such as camera sensor, X-ray sensors, weight sensors, barcode/RFID sensors etc. start capturing the raw data e.g. weight, height, content, volume, condition etc. of the item. The vision module receives all the data from all the sensor and stores it in a local or remote memory of the database. The Kiosk is adapted to process the raw data and identify the primary data by using object and character recognition (OCR) module and the artificial intelligence (AI) module. The kiosk is adapted to identified any abnormalities, such as item used, item damaged, the difference between the returned item and the original item. If there are no abnormalities the return become successful. However, if the Kiosk's OCR and/or AI finds any abnormalities, the kiosk may reject the return process based on the level of abnormalities based on the retailer's policies for incomplete returns.

The kiosk generates fingerprint data of the user and stores the fingerprint data on the block chain. Then, the user gets the refund or the exchanged item based on the user input e.g. if the user selects the refund option or replacement option.

In another aspect of the present invention, a user can transmit the user input i.e. request for exchange an item, request for the refund, request for return an item, via a remote device such as a computer or a smart phone which communicates with the self-operating kiosk device.

In another aspect of the present invention, the kiosk builds a database for fraudulent customers via facial recognition.

Further, in another aspect of the invention, the kiosk builds a database for loyal and reliable customers and based on their profiles it offers gift cards, rewards, and other loyalty bonuses to the customers.

Other variations, systems, methods, embodiments, features, and advantages of the present invention will be or will become apparent to one skilled in the art upon examination of the following detailed description, drawings, and claims. It is intended that all such additional systems, methods, embodiments, features, and advantages be included within the scope of and be protected by the accompanying claims.

The foregoing has outlined, rather broadly, the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a complete understanding of the present invention, reference is now made to the following descriptions taken in conjunction with the accompanying drawings, in which:

FIG. 1 illustrates a block diagram showing various component of the self-operating kiosk device, according to the various embodiments of the present invention;

FIG. 2 illustrates a self-operating kiosk device for facilitating return, exchange and purchasing experience according to the various embodiments of the present invention;

FIG. 3 illustrates a self-operating kiosk device attached to a conveyor belt system for transferring the item from an automated inventory or store to the kiosk device and vice versa, according to the various embodiments of the present invention;

FIG. 4 illustrates a flowchart explaining how item data is processed by the self-operating kiosk and store the fingerprint data to the block chain, according to the various embodiments of the present invention;

FIG. 5 illustrates a flowchart explaining the selecting of a shopping option or item return/exchange at the kiosk by a user, according to the various embodiments of the present invention;

FIGS. 6 and 7 illustrates a flowchart explaining how a user purchases at least one item from the retail store via the kiosk device, according to the various embodiments of the present invention;

FIGS. 8, 9, and 10 illustrates a flowchart explaining how a user returns or exchanges at least one item at the retail store via the kiosk device, according to the various embodiments of the present invention;

### DETAILED DESCRIPTION OF THE INVENTION

Embodiments of the present disclosure will be described more fully hereinafter with reference to the accompanying drawings in which like numerals represent like elements throughout the several figures and description, and in which example embodiments are shown. Embodiments of the claims may, however, be embodied in many different forms and should not be construed as limited to the embodiments set forth herein are departing from the scope of the present invention with respect to the disclosed embodiments. The examples set forth herein are non-limiting examples and are merely examples of other possible aspects and embodiments of the present invention.

As will be appreciated by one skilled in the art, aspects of the present invention may be embodied as a system, method, computer program product, or combinations thereof. Accordingly, aspects of the present invention may take the form of an entire hardware embodiment, an entire software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon, and, generally, operable with various hardware elements including those disclosed herein.

Any combination of one or more computer readable medium(s) referred herein as memory or storage unit may be utilized for storing customer and product information data. The computer readable medium may be a computer readable signal medium or a computer readable storage medium such as, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code or software embodied on a computer readable medium or memory unit may be transmitted using any appropriate medium, including but not limited to wireless, wired, optical fibre cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a stand-alone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” such artificial intelligence module as used herein refers to any known or later developed hardware, software, firmware, artificial intelligence, fuzzy logic, machine learning algorithm, deep learning algorithm or combination of hardware and software that is capable of performing the functionality associated with that element. The module can consist of a software agent, a fuzzy logic algorithm, a predictive algorithm, an intelligence rendering algorithm, object recognition module and optical character recognition and a self-learning (including relearning) algorithm. It should be noted that the self-learning (including relearning) algorithm can include a self-learning artificial intelligence algorithm and/or a self-learning neural network algorithm and/or a quantum computer enhanced machine learning algorithm.

The terms “determine”, “calculate” and “compute,” and variations thereof, as used herein, are used interchangeably and include any type of methodology, process, mathematical operation or technique.

The term “computing device” described herein below refers to any processing device, and may include mobile phones, smart phones or PDAs, Tablet computing devices and the like. In one embodiment, a computing device is a touchscreen device for receiving an input from a user via touch, voice, gesture and other computing devices.

The term “item” described herein below refers to any product, goods, article, food, electronic circuit or IC chips and may include any product which is used as a commodity and sell/purchased/manufactured.

In some embodiments, the mobile device can be a primarily software-based application (“APP”) (e.g., a software application programmed to operate on a mobile phone operating system (iOS, Android, BlackBerry OS, etc.)) or a dedicated mobile device (e.g., a device having circuitry programmed (e.g., in ROM) to perform features of the described technology). In various embodiments, the mobile device is configured to operate with all or portions of traditional wireless hardware (e.g., Bluetooth, Wi-Fi, NFC, and RF); however, the APP or other features of the described technology may augment, modify, replace, or otherwise change any drivers, protocols, or software components used to operate the wireless hardware. This allows the described technology to use “off the shelf” wireless hardware technology (e.g., Bluetooth-configured circuitry) that is currently available in most mobile devices without the software overhead to comply with the often overly complex and inefficient wireless technology communication protocol standards.

In some embodiments, the described technology facilitates and or enables a visually impaired user to locate or “discover” one or more wireless kiosks. For example, the mobile device can broadcast or unicast a wireless discovery message requesting a response from any wireless kiosk within a selected or automatically-determined range. In various embodiments, each kiosk “listens” (i.e., are configured to receive discovery messages) for the request and responds with its kiosk identifier, which distinguishes the kiosk from other kiosks. In various embodiments, after the mobile device discovers a kiosk, the mobile device and or the kiosk establish a communicative session to facilitate, for example, rent, purchase, and or return or exchange operations, based on one or more requests made at the mobile device. In some embodiments, the discovery process is performed separately from another kiosk operation (e.g., the discovery process is manually selected at the mobile device) or, in other embodiments, the discovery process it is automatically performed when a kiosk operation is selected at the mobile device. For example, when a kiosk command is selected, the mobile device will first perform a discovery process, and then proceed with the rent, purchase, and or return or exchange operations.

The following description provides specific details for a thorough understanding and enabling description of the presented embodiments. One skilled in the art will understand, however, that the described technology may be practiced without many of the foregoing or subsequent details. Additionally, some well-known structures or functions may not be shown or described in detail, so as to avoid unnecessarily obscuring the relevant description of the various embodiments.

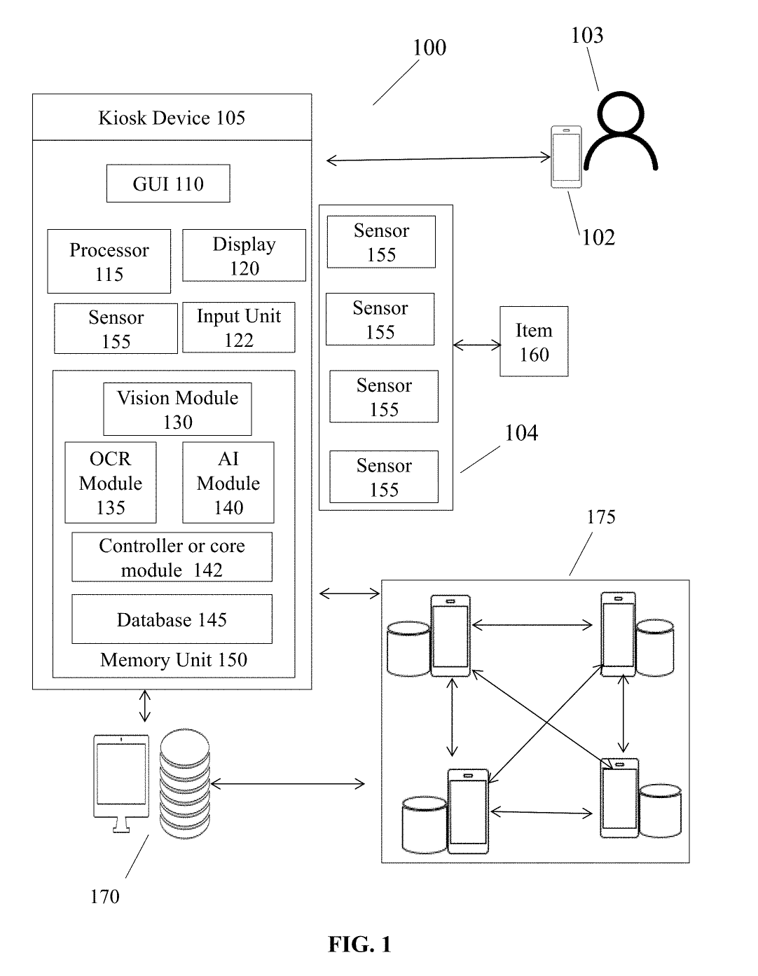

Some embodiments of this invention, illustrating all its features, will now be discussed in detail with respect and relevance to FIGS. 1 to 10 as required for understanding.

The present invention relates to a self-operating networked or wireless enabled kiosk device for providing an easy return, exchange and purchasing experience in a retail store environment. The kiosk device includes a touchscreen for receiving an input from a user, the input relates to at least one action to be performed in relation to the item, a vision module communicably coupled to the said computing device and at least one sensor, such that the vision module captures a raw data related to the said item via the at least one sensor based on the at least one action and stores the raw data in a memory, an object recognition module and optical character recognition (OCR) modules configured to identify a primary data from the raw data based on at least one predefined parameter and store the primary data in the memory, wherein the primary data is associated with the said item and an artificial intelligence (AI) module adapted to retrieve the raw data and primary data from the memory to generate a second fingerprint data based on the primary data and the at least one predefined parameter, wherein the AI module is configured to identifying at least one first block having a first fingerprint data related to the item, the first block stored on a networked distributed ledger and creating a second block including the first fingerprint data and the second fingerprint data on the networked distributed ledger.

The self-operating kiosk device facilitates the purchase of at least one item. The purchasing is done at the kiosk by a user via using the touch screen user interface. The purchasing item information is transferred from the automated inventory or manual inventory to the kiosk upon successful transaction. The automated inventory selects the purchased item from the automated inventory item warehouse or the automated retail store and puts the purchased item on the conveyor belt system. The conveyor belt system transfers the purchased item to the receptacle of the kiosk, where the user can pick a product and checkout the retail store. The kiosk allows a user to deposit traditional currency (e.g., United States dollars) for cash payment or user and opt different type of payment option such credit/debit card, NFC payment, internet banking, mobile banking and the like

In practice, the self-operating device facilitates the return of the purchased item at the kiosk in a facilitated manner. A first stage comprises: (i) User provides the item return request to the kiosk via touch screen user interface; (ii) Based on the request, a user is prompted to place the item and the receipt of the item is available on the receiving area of the item receiving unit; (iii) the sensor attached to the item receiving unit detects the presence of the item and triggers the processing of the item via sensors such as camera sensor, X-ray sensors, weight sensor, barcode/RFID sensor etc. and start capturing the raw data of the item in vision module. The vision module receives all data from all of the sensors and stores it in a local or remote memory. The Kiosk is adapted to process the raw data and identify the primary data by using object recognition module and optical character recognition module and artificial intelligence module. The kiosk is adapted to identify any abnormalities in the return item. If there are no abnormalities the return become successful. But if the Kiosk found any abnormalities, the kiosk reject the return process based on the level of abnormalities.

FIG. 1 illustrates a wireless kiosk system 100 in accordance with an embodiment of the present invention. FIG. 1 shows a mobile device 102 and a wireless kiosk device 105. The wireless kiosk 105, as described above, is adapted to facilitate an easy rent, purchase and return/exchange process in a retail store, shopping mall, warehouse or inventory and the like. For example, the mobile device 102 is a wireless computing device (e.g., phone, tablet, laptop, computerized glasses, etc.) configured to wirelessly communicate to the kiosk 105. The kiosk 105 device is adapted to receive input from the user via the mobile device 102. The mobile device 102 includes a mobile application which provides the same user interface as that used in the kiosk device 105 so that the user 103 can interact with the kiosk 10X through the mobile device 102 and perform all the functions similarly as when the user 103 directly interacts with the kiosk device 105. In one embodiment, the mobile device 102 can be an iPhone, Android, Windows, or BlackBerry-enabled phone, etc. and an accessibility application (APP) that provides features of the described technology installed on the mobile device 102. In another embodiment, the App can be hardwired into a mobile device dedicated to performing vending operations. In some embodiments, the mobile device 102 has a touch screen for manipulating the App; however, the described technology can be implemented with other hardware- and or software-based features.

Aspects of the self-operating or self-operable wireless enabled kiosk system 100 may be practiced in a variety of computing environments in which the mobile device 102 and or the kiosk 105 device, may be implemented. Although not required, aspects of the technology may be described herein in the general context of computer-executable instructions, such as routines executed by a general or special purpose data processing device (e.g., a mobile client, kiosk, server, thin-client, or client computer). Aspects of the technology described herein may be stored or distributed on tangible computer-readable media, including magnetically or optically readable computer discs, hardwired or preprogramed chips (e.g., EEPROM semiconductor chips), nanotechnology memory, biological memory, or other data storage media. Alternatively, computer implemented instructions, data structures, screen displays, and other data related to the technology may be distributed over the Internet or over other networks (including wireless networks) on a propagated signal on a propagation medium (e.g., electromagnetic wave(s), sound wave(s), etc.) over a period of time. In some implementations, the data may be provided on any analog or digital network (packet switched, circuit switched, or another scheme).

The described technology can also be practiced in distributed computing environments, where tasks or components are performed by remote processing devices, which are linked through a communication network, such as a Personal Area Network (“PAN”), Local Area Network (“LAN”), Wide Area Network (“WAN”), Near Field Communication (“NFC”), Mobile networks (e.g., floating networks based on devices at least partially residing in the atmosphere—stratosphere, troposphere, mesosphere), and or the Internet. For simplicity, the described technology describes Bluetooth technology as an example communication network. In a distributed computing environment, program components or sub-routines may be located in both local and remote memory storage devices. Those skilled in the relevant art will recognize that portions of the described technology may reside on a server computer (e.g., kiosk), while corresponding portions reside on a client computer (e.g., a thin-client, or the APP). Data structures and transmission of data particular to aspects of the technology are also encompassed within the scope of the described technology.

The data storage devices or memory 150 may include any type of computer-readable media that can store data accessible by the computer 200, such as magnetic hard and floppy disk drives, optical disk drives, magnetic cassettes, tape drives, flash memory cards, digital versatile disks (DVDs), Bernoulli cartridges, RAMs, ROMs, smart cards, etc. Indeed, any medium for storing or transmitting computer-readable instructions and data may be employed, including a connection port to or node on a network, such as a PAN, LAN, WAN, or the Internet.

Again Referring to FIG. 1 of the drawings, there is shown a kiosk system 100. The system 100 shows a self-operating networked kiosk 105 which includes a touchscreen for inputting information. The kiosk device 105 includes a user interface of a pre-stored application for receiving an input from the user via touch screen display 120. The user enters an input in the said Graphical User Interface (GUI) 110. The input may relate to at least an action to be performed by the user such as the purchase of item 160, the return of item 160, transfer of custody of item 160 and the like. Further, in one embodiment, the input which includes at least one action to be performed by the user, such as the purchase of item 160, the return of item 160, transfer of custody of item 160 and the like is received from the mobile device 102

In the present system, the kiosk device 105 comprises a processor 115 and a display 120 and an internal sensor 155.

Additionally, there is a memory unit 150 which comprises a Vision Module 130, OCR module 135, AI module 140, core module 142 and a database 145. The vision module 130 is configured to capture raw data related to the said item 160 via internal and the external sensor 155. The raw data relates to information about the item such as the type of item, date of manufacturing of the item, the model number of the item, the brand name of the item and the like. These should not be construed as a limitation, there could be additional information also.

In one embodiment of the present invention, the core module 142 is a software module. The core module 142 hold all the other software module altogether. The core module 142 is a controller module which controls all module and their functionality. The core module 142 is adapted to trigger or activate other modules based on the user input and system or device requirement. The core module 142 gives out instructions, gets back data and then gives out more instructions and also helps train and reinforce the learning of all the 3 AI's i.e. vision module 130, the object recognition, and optical character recognition OCR135 and databasing and decision-making module AI 140. The AI's are vision module 130, the object recognition, and optical character recognition OCR 135 and databasing and decision-making module AI 140, the databasing AI will be checking it against various databases for various aspects that are in addition to the 2 vision AI systems. The databasing means indexing, categorizing and cataloging the primary and raw data in the database.

In one embodiment of the present invention, a Vision Module 130, OCR module 135, AI module 140, Core or controller module 142 is software agent or module which is capable of proffering all the functionality as described herein. The Vision Module 130, OCR module 135, AI module 140, core module 142 is communicably coupled to all the component of the system to perform various functionality. The Vision Module 130, OCR module 135, AI module 140, Core or controller module 142 is software agent or module which executed or run by at least one processor. The Vision Module 130, OCR module 135, AI module 140, Core or controller module 142 are adapted to run in any computing device such mobile phone, kiosk, laptop, tablet, and processor enable computing device.

In one embodiment of the present invention, the Core module 142 is adapted to monitor the GUI 110, sensors 155 Vision Module 130, OCR module 135 and AI module 140 and their functionality. The Core module 142 is connected to each of the AI's (130, 135 and 140) module, processor 115, GUI 110, database 145, the sensors 155, block chain 175, server 172 and storage devices (remote database) 150. The Core module 142 allows all the component of the system to communicate with each other and perform their functionality based on the communication.

The sensor 155 is selected from at least one of a Digital Camera, Video Device, Microscopic Camera, high resolution image sensor, motion sensor, weight sensor, x-ray sensor, camera sensor, Temperature Sensor, Proximity Sensor, Accelerometer, IR Sensor (Infrared Sensor), Pressure Sensor, Light Sensor, Ultrasonic Sensor, Smoke, Gas and Alcohol Sensor, Touch Sensor, Colour Sensor, Humidity sensor, Tilt Sensor, Flow and Level Sensor, Touch Sensor, barcode reader, RFID reader. X-Ray, SEM or other sensory/validation devices and the combination thereof.

The raw data captured by the vision module is stored in a memory unit 150.

The object and character recognition (OCR) module 135 is configured to identify a primary data from the raw data based on at least one predefined parameter and stores the primary data in the memory unit 150. The identified primary data is associated with the said item 160.

The system 100 includes an Artificial Intelligence (AI) module 125 adapted to retrieve the raw data and primary data from the memory and generates a second fingerprint data based on the primary data and the at least one predefined parameter. The AI module 125 is adapted to accept all data and images and builds profiles for the item. The AI module is adapted to create a learning database or training database information to improve its functionality for future images. The AI module is adapted to analyze all captured OCR data to perform a search against block chain relation item database. For example, Make: Lenovo |Model: Y580p|Serial Number: CB31957208|Mfg. Date: Sep. 19, 2017.

The system 100 includes at least one remote server 170 having a remote database. The at least one remote server 170 is connected to each node or computing device in the block chain system. Each node or computing devices are interconnected to each other and creating a distributed ledger or block chain environment. The AI module 140 present in each node is adapted to send information when the item is processed, to the remote server 170 and store in the remote database. The remote database 170 stores all the raw data, primary data, fingerprint data, abnormalities identification parameter. The remote database is self-updating or self-learning or a trained database which is trained by the AI module 140.

The AI module 140 integrates stored information, real-time information, information/data/image(s) from the object/array of objects (where the object can be coupled with a wireless (or radio) transmitter and/or a sensor) and the unified algorithm (which includes a software agent, a fuzzy logic algorithm, a predictive algorithm, an intelligence rendering algorithm and a self-learning (including relearning) algorithm). The vision module 130, AI module 140 and OCR module 135 perform artificial intelligence, data interpretation, data mining, machine vision, natural language processing, neural network, object recognition, pattern recognition and reasoning modeling.

In an embodiment, at the retailer end, the AI module 140 is trained to pre-store information about every item stocked in the respective store. It includes a huge reference library for all different shapes and sizes and other identifying characteristics that may be visible.

In an embodiment, the AI module 140 is adapted to retrieve the transaction data and user data related to the item stored in the memory unit 150 or in the remote database 170. Further, the AI module is adapted to add the transaction data and user data related to the item to the fingerprint data.

The AI module 140 is configured to identify at least one first block which has a first fingerprint data related to the item. The said first block is stored in a networked distributed ledger.

The AI module 140 creates a second block including the first fingerprint data and the second fingerprint data at every change in custody of the item in the supply chain management.

In an embodiment, the AI module 140 also generates a second fingerprint based on the image, which includes characteristics of the item but not limited to manufacturer, model, UPC number, lot number, serial number, date, time etc. It also identifies any packaging details such as whether the item is sealed in manufacturer's original packaging, the item has been opened but is in original manufacturer packaging, loose item, if it is a loose item it will verify cosmetic condition and completeness i.e. if anything is broken, crack, scratched, missing such as accessories etch during the purchasing and return/exchange process.

The AI module 140 authenticates the item after matching the second fingerprint data with pre-stored abnormalities identification parameter includes x-ray images, weight of the item or sub-items within the package, total weight of the item with or with packaging, printing pattern, text style, coloured used on the text or colours used on the packaging, watermark information, completing packaging information, labelling information and special markings, barcode information, item information such as UPC code, serial number, manufacturer name, data captured by each sensor when item is processed by the system at genesis or first time and the like.

In an embodiment, the first fingerprint and the second fingerprint comprise time stamp when the fingerprints are created. The time stamp enables the identifying of the last point of custody where the fingerprint has been generated. The time stamp could be in format such as, Date, time [hh]: [mm]: [ss].

After the AI module 140 has produced primary data from the Analysis of the Vision Component inputs, the AI module 140 takes all data and generates, calculates or computes a Cryptographic Hash or fingerprint data. The Cryptographic Hash stores any or all relevant, identified, discovered, generated, calculated, defined and or predefined data as determined by both inputs from the Vision module 130 and inputs from the Artificial Intelligence module 140. This data can include external data from additional inputs. This data from additional inputs can include internal or external sensors, external or internal data observed, analyzed, identified, discovered, generated, and calculated during purchasing, return/exchange process.

Once the Cryptographic Hash is generated, also known as a Block; it will then be recorded and or registered on the Block chain and or Relevant Database, DataSet or another registry. The Cryptographic Hash is to include any and all analysed, identified, discovered, generated, calculated data and which may or will contain any or all information as to company, operator, location, time, date and other relevant data including data related to the use of, operation of, software of, license of, security of, value of, owner of and other relevant of.

Once the Cryptographic Hash or fingerprint data is recorded to the Block Chain Component and or Relevant Database, DataSet and or another registry the process is now complete and the record will now be available to the inquiry at any time by repeating the process as stated above.

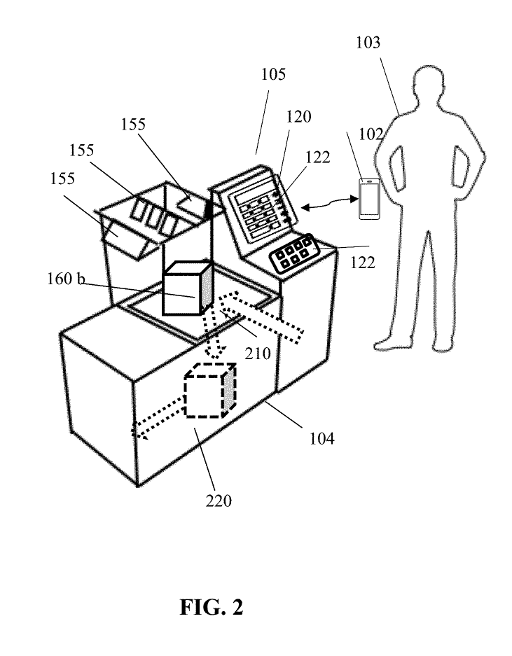

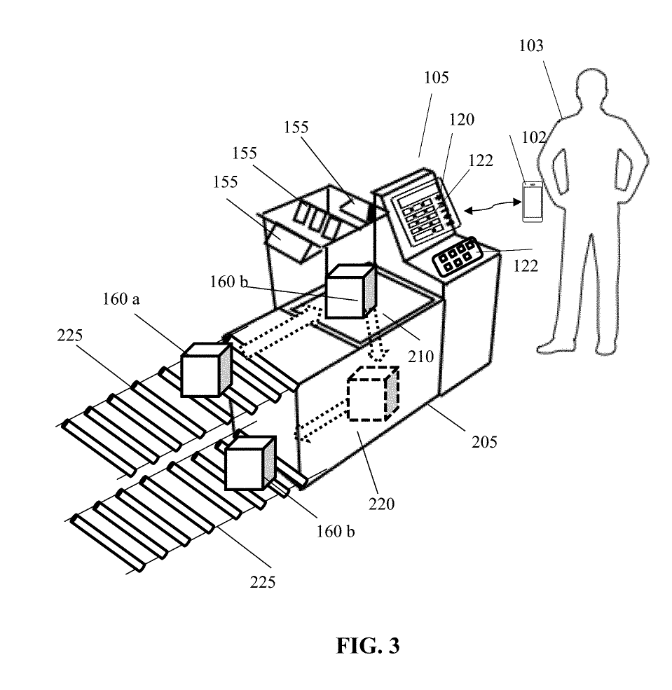

Referring to FIG. 2-3, The FIG. 2 illustrates the self-operating networked kiosk 105 includes a receptacle or the receiving unit 104 having a receiving area 210 for receiving the item, wherein at least one sensor 155 is attached to the receptacle. The at least one sensor 155 is hanged over receiving area 210. The at least one sensor 155 is configured with to the receiving area 210. a receptacle or the receiving unit further includes at least one robotic arm (not shown) is attached to the receptacle for fixing the item 160b at the desired position. Wherein the item 160b is a return item. The kiosk 105 is adapted to prompt the user 103 via the display 120 to place the return item on the receiving area 210 along with the receipt of the item 160b. Further, the receptacle or the receiving unit 104 includes a hollow enclosure 220 to store the return item. A receiving area 210 is openable in nature. Further, a lift is attached to the receiving area 210 to pull the receiving area having at least one returned item 160b within the hollow enclosure 220 and unload the returned item within the hollow enclosure 220. After unloading the returned item the receiving area 210 is returned to its position by using the lift. The receiving area 210 is adapted to receive at least one purchase item 160 form the user or agent manually or from the automated inventory via an automatic product transfer system 225.

In one embodiment of the present invention, The kiosk device is adapted to receive and transfer at least one item to the receiving unit 205 from an automated inventory (not shown) through an automatic product transfer system 225 based on the input received from the user via the at least one user interface, wherein the automatic product transfer system 225 includes at least one conveyor belt system having a first end attached to the receiving unit 205 and a second end attached to an automated inventory for transferring the at least one item 165a to the receiving unit 225 from the automated inventory and vice versa.

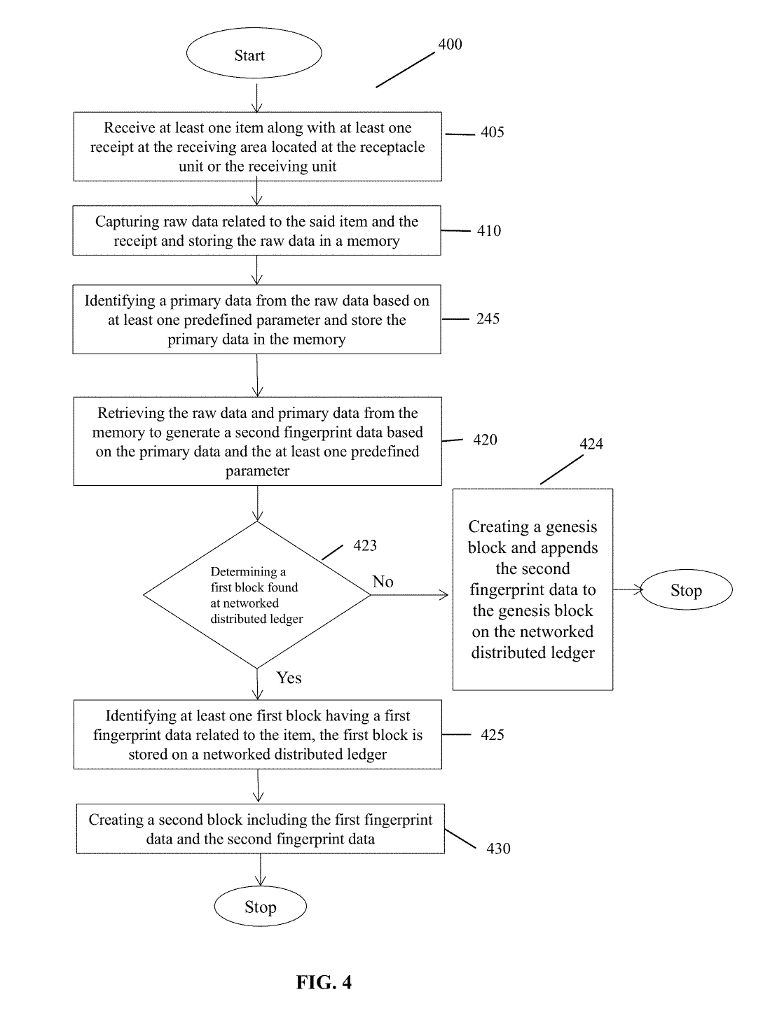

Referring to FIG. 4, there is disclosed a method 400 which is practiced by the kiosk device for processing the items based on the at least one input which related to at least one action received from the user. The input includes an item purchase request, item return/exchange request. The method 400 starts at step 405 for receiving an input at the kiosk for performing an action related to an item. The input is received on a user interface of a pre-stored application on kiosk 105 or the input received from the mobile device of the user by the kiosk device 105. The user enters an input in the said user interface. The input may relate to at least an action to be performed by the user such as purchasing of an item, returning of an item, transferring custody of an item and the like. The item is processed every time at each purchasing of an item, returning of an item or exchanging of the item. The new user is adapted to process the item before accepting it via Kiosk device 105 The processing of item means the item will be scanned, verified and create a block where the information is stored in block chain distributed ledger at each point where the custody of the item changed.

Upon receiving the input from the user, at step 410, the vision module 130 is adapted to activate all the sensors which capturing of raw data of the item at step 245. The external or internal sensors 155 are at least one of a Digital Camera, Video Device, Microscopic Camera, high resolution image sensor, motion sensor, weight sensor, x-ray sensor, camera sensor, Temperature Sensor, Proximity Sensor, Accelerometer, IR Sensor (Infrared Sensor), Pressure Sensor, Light Sensor, Ultrasonic Sensor, Smoke, Gas and Alcohol Sensor, Touch Sensor, Colour Sensor, Humidity sensor, Tilt Sensor, Flow and Level Sensor, Touch Sensor, barcode reader, RFID reader. X-Ray, SEM or other sensory/validation devices and the combination thereof.

The raw data includes data of the item captured by each of the sensors which includes barcode information, RFID information, images of packaging, image of the item or package, X-ray images from all side, weight of the item, weight each component of items within the packaging, printing pattern or coloured used on the packaging, watermark information, packaging, labelling and markings and the like. Once the raw data is captured, it is stored in the memory via the vision module 130.

In an embodiment, the raw data relates to information about the item such as UPC code, serial number, the type of item, date of manufacturing of the item, the model number of the item, the brand name of the item and the like. These should not be construed as a limitation, there could be additional information also.

At step 415, after capturing and storing the raw data, the system is adapted to send the raw data to OCR module 135, the OCR module is adapted to identify the important information or primary data from the raw data based on at least one predefined parameter and store the primary data in the memory. The identification of primary data is performed by identifying the region of interest in the image and identifying the object or character in that region. If the region of interest includes characters, the OCR module 135 is adapted to identify the letters and make meaning full data. Further, if the region of interest is an object or an image related to the item, then the OCR is adapted to identify the image for example whether the image is laptop image or mobile phone image etc. and cataloged the primary data the stored the databased within the memory.

Further, OCR module 135 includes a logic connected to a database such that the database includes pre-stored cataloged data of image and characters from the pre-stored image. The data is collected whenever an item is processed. The OCR module 135 identifies the region of interest based on object and character recognition algorithm and compares with pre-stored data to identify the item and its information. In an embodiment, whenever a new or unique image or character/object is unrecognizable, then a manual input about the image or character/object is provided by the administrator. That information of a new or unique image or character/object are unrecognizable is stored in the data and cataloged. So, that if in future, the same type of character or object or image comes, the OCR module recognizes it and catalogs the data. This process is also known as a self-learning process which is achieved by using machine learning and deep learning software. The region of interest is identified based on the at least one predefined parameter. The at least one predefined parameter includes item related information such as the type of item, serial number, maker information, manufacturing information or any information relating the item.

At step 420, AI module 140 is configured to retrieve the raw data and primary data step 245 from the memory to generate a second fingerprint data based on the primary data and the at least one predefined parameter. The AI module 140 is adapted to use the cataloged data stored in the memory to create a learning database. The learning database is updated automatically whenever a new, unique data or unrecognizable data is cataloged, so that the cataloged data is used in the future for identifying the information by comparing with the pre-stored cataloged data.

In an embodiment, at the retailer end, the AI module 140 is trained to pre-store information about every item stocked in the respective store. It includes a huge reference library for all different shapes and sizes and other identifying characteristics that may be visible.

At step 423, the AI module 140 identifies a first block related to the identified product is determined in a networked distributed ledger. If the first block is found at step 423, the method moves to step 425.

If the first block is not determined on the distributed ledger at step 423, the method is adapted to Create a genesis block and appends the second fingerprint data to the genesis block on the networked distributed ledger at step 424 and the method stops.

At step 425, identification of at least one first block having a first fingerprint data related to the item, the first block is stored on a networked distributed ledger. The first fingerprint data is created at the previous change of custody point by a computing device by processing the item in the same manner described above. The networked distributed ledger relates to a replicated, shared and synchronized digital data which is accessible to all the points for changing the custody of the item in the supply chain management system.

Referring again to method 400, at step 430, creating a second block including the first fingerprint data address and the second fingerprint data on the distributed ledger or block chain.

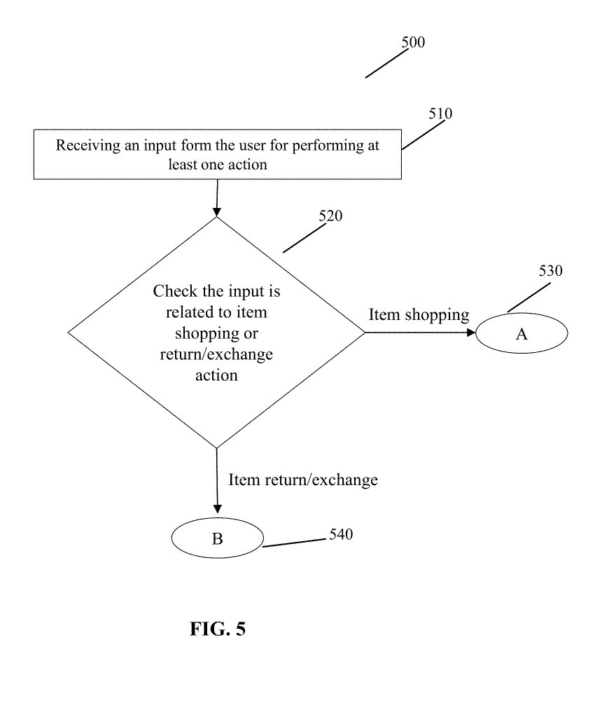

Referring to FIG. 5, there is disclosed a method 500, The method 500 starts at step 510 for receiving an input at the kiosk for performing an action related to an item. The method allows the Kiosk device to check at step 520 if the input is related to item shopping/purchasing, item return/exchange. If the input includes a request of item shopping, then method initiates the item shopping/purchasing process 530 for the user at kiosk device. If the input is related to item return/exchange. The method is adapted to initiate the process for returning/exchanging the item at step 540.

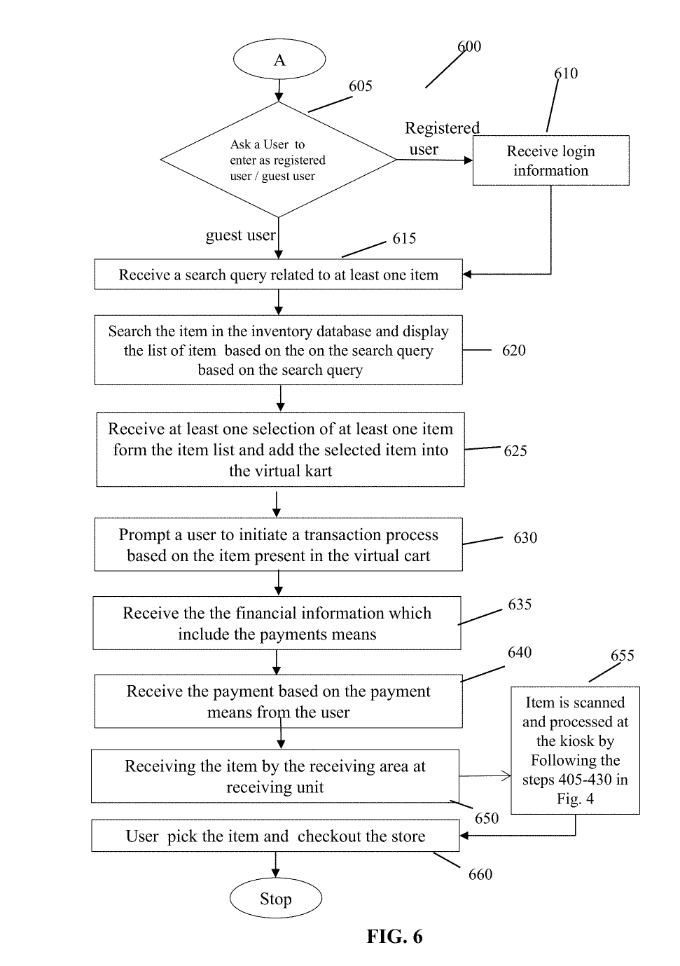

Referring to FIG. 6, there is disclosed a method 600 for shopping at least one item via kiosk device, at step 605 Based on the user input for shopping/purchasing, the method is adapted to allow Kiosk device 105 to ask a User 103 to enter as a registered user/guest user via the graphical user interface 122 displayed on the touch screen 120. Further, at step 610 the method is adapted to allow the user to register itself on the system by creating a user name and password. Now at step 615, the method allows the kiosk device 105 to receives at least one search query related an item 160a user want to purchase through user input device such touch screen, keyboard etches or through the mobile device 102 at kiosk device 105. The method allows the kiosk device 105 to search the item in the inventory database and display the list of the item based on the on the search query on the touch screen 120 through the GUI 122 at step 620. The method is adapted to receive at least one selection of at least one item from the item list and add the selected item into the virtual kart at step 625. The method allows the kiosk device to prompt the user via GUI or through mobile device 102 mobile application to initiate a transaction process based on the item present in the virtual cart at step 630. The method allows the kiosk device to receive the receive the financial information such as credit card information, secure login information for internet backing and the like which include the payments means at step 635, wherein the payment means paying the payment through credit/debit card, store card, digital wallet, universal payment gateway, bitcoin, online internet banking, cash and the like. At step 640, the method is adapted to receive the payment based on the payment means from the user. The purchased item is received at receiving unit at step 650 and perform the steps from 405-430 as described in FIG. 4 at step 655. After processing the item at 655, The method allows the kiosk to notify the user to collect or pick the item. Further, at step 660 the user picks the item and checkout from the store.

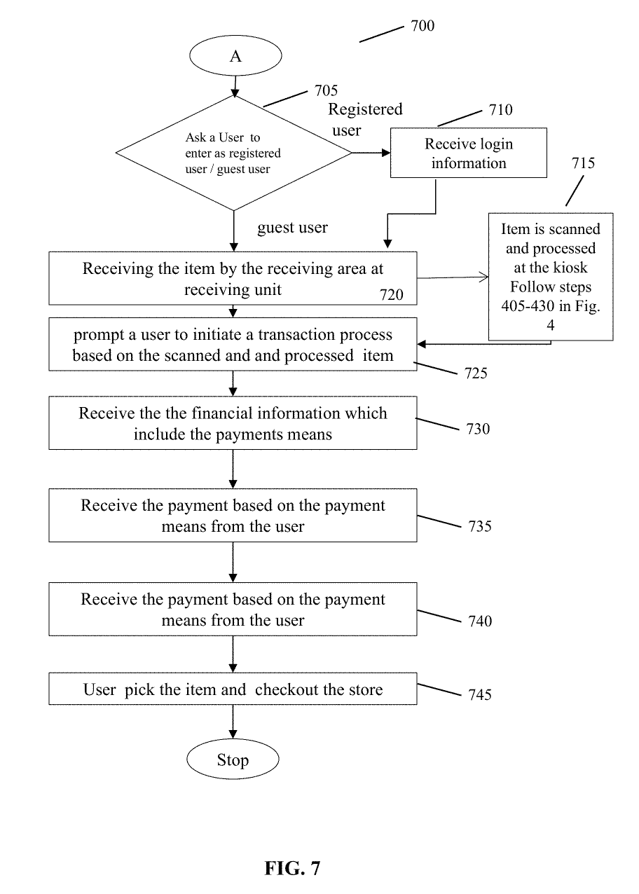

Referring to FIG. 7, there is disclosed a method 700 for shopping at least one item and checkout at kiosk device without the need for any sales person or agent. The user can pick at least one item and go to a kiosk to check out. The method is adapted to allow Kiosk device 105 to ask a User 103 to enter as registered user/guest user via the graphical user interface 122 displayed on the touch screen 120 at step 705. Further, at step 710 the method is adapted allow the user to register itself on the system by creating a user name and password. The method is adapted to prompt the user via GUI through the touch screen or through a mobile device to put the selected item on the receiving area of the receiving unit at step 720 and perform the steps from 405-430 as described in FIG. 4 at step 715. After processing the item at 715. The method is adapted to prompt a user to initiate a transaction process based on the scanned and processed item at step 730. The method allows the kiosk device to receive the receive the financial information such as credit card information, secure login information for internet banking and the like which include the payments means at step 735, wherein the payment means paying the payment through credit/debit card, store card, digital wallet, universal payment gateway, bitcoin, online internet banking, cash and the like. At step 740, the method is adapted to receive the payment based on the payment means from the user. After successful payment, the user is adapted to collect the purchased item from the receiving unit at step 745.

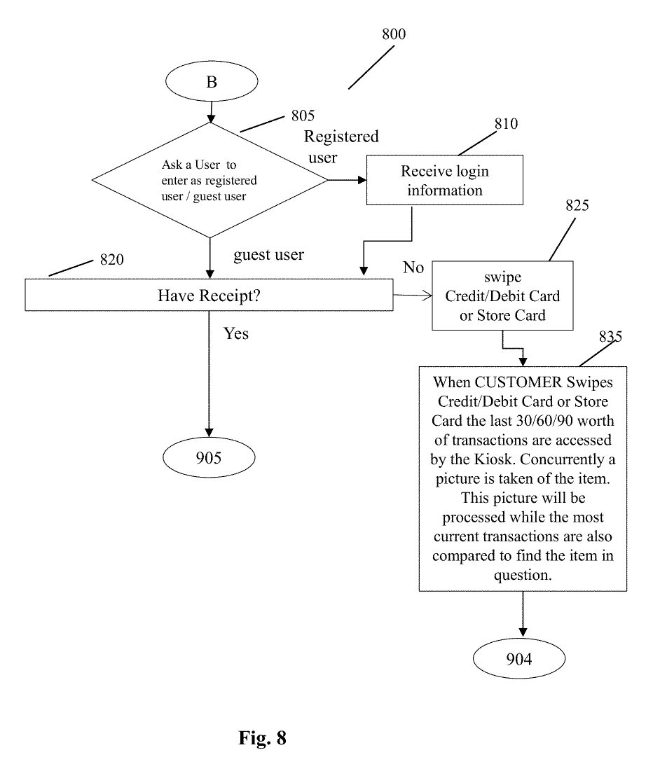

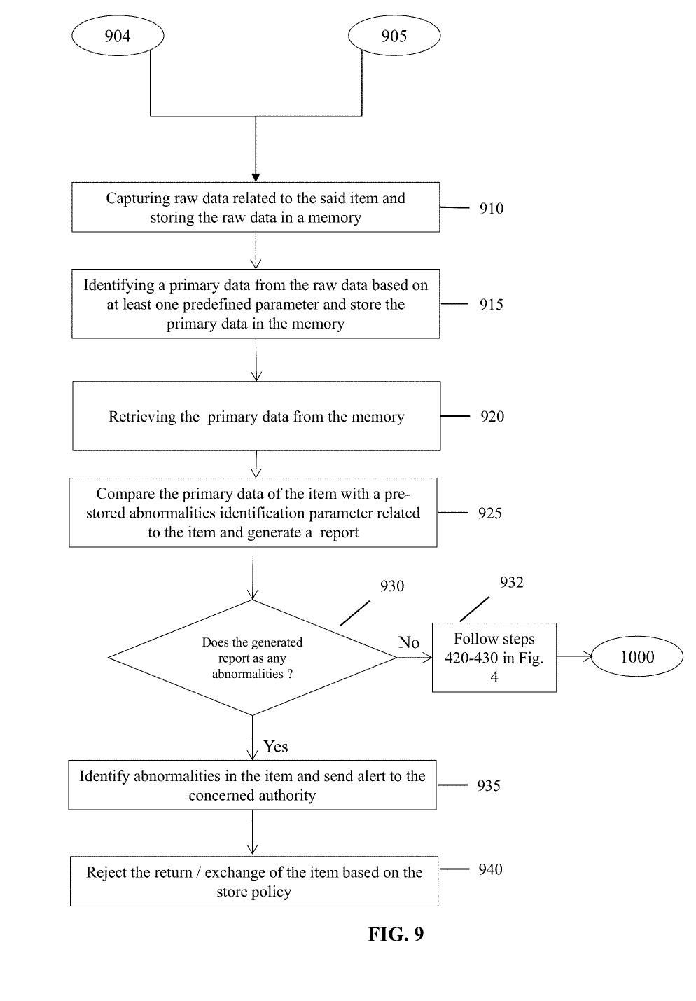

Referring to FIG. 8, there is disclosed a method 800 for returning at least one item and checkout at kiosk device without the need for any sales person or agent. The user can pick at least one return item and go to a kiosk for check out. Based on the user input which includes return item request, the method is adapted to initiate a return process, the method allows Kiosk device 105 to ask a User 103 to enter as registered user/guest user via the graphical user interface 122 displayed on the touch screen 120 at step 805. Further, the method is adapted allow the user to register itself on the system by creating a user name and password and receive login information from another user to provide access to the kiosk system at step 810. The method is adapted to prompt the user via the GUI displayed on the touch screen about the availability of the receipt at step 820, if yes, Then the method is adapted to prompt the user via GUI through the touch screen or through mobile device to put receipt on the top of the return item and placed the return item along with the receipt on the receiving area of the receiving unit at step 905 as shown in FIG. 9. If the user does not have the receipt, then the method is adapted to prompt the user to swipe Credit/Debit Card or Store Card at step 825, wherein the Kiosk includes a card reader unit. The method allows the kiosk to access the last 30/60/90 worth of transactions Concurrently a picture is taken of the item at step 835. This picture will be processed while the most current transactions are also compared to find the item in question at step 904. The method is to prompt the user to place the return item on the receiving area of the receiving unit at step 905

Referring to FIG. 9, after completion of step 904 or 905, the vision module 130 at step 910 is adapted to active all the sensors which capturing of raw data of the item. at least one of a Digital Camera, Video Device, Microscopic Camera, high resolution image sensor, motion sensor, weight sensor, x-ray sensor, camera sensor, Temperature Sensor, Proximity Sensor, Accelerometer, IR Sensor (Infrared Sensor), Pressure Sensor, Light Sensor, Ultrasonic Sensor, Smoke, Gas and Alcohol Sensor, Touch Sensor, Color Sensor, Humidity sensor, Tilt Sensor, Flow and Level Sensor, Touch Sensor, barcode reader, RFID reader. X-Ray, SEM or other sensory/validation devices and the combination thereof.

At step 915, after capturing and storing the raw data, the system is adapted to send the raw data to OCR module 135, the OCR module is adapted to identify the important information or primary data from the raw data based on at least one predefined parameter and store the primary data in the memory. The identification of primary data is performed by identifying the region of interest in the image and identifying the object or character in that region. If the region of interest includes characters, the OCR module 135 is adapted to identify the letters and make meaning full data. Further, if the region of interest is an object or an image related to the item, then the OCR is adapted to identify the image for example whether the image is laptop image or mobile phone image etc. and cataloged the primary data the stored the databased within the memory.

At step 920, AI module 140 is configured to retrieve the raw data and primary data from the memory to generate a second fingerprint data based on the primary data and the at least one predefined parameter. The AI module 140 is adapted to use the cataloged data stored in the memory to create a learning database. The learning database is updated automatically whenever a new, unique data or unrecognizable data is cataloged, so that the cataloged data is used in the future for identifying the information by comparing with the pre-stored cataloged data.

At step 925, comparing of the primary data of the item with a pre-stored abnormalities identification parameter related to the item is done and generating an abnormalities report. The abnormalities identification parameter includes x-ray images, weight of the item or sub-items within the package, total weight of the item with or with packaging, printing pattern, text style, coloured used on the text or colours used on the packaging, watermark information, completing packaging information, labelling information and special markings, barcode information, item information such as UPC code, serial number, manufacturer name, data captured by each sensor when item is processed by the system at genesis or first time and the like.

In one embodiment, the abnormalities can be of different types such as missing sub items form the items, counterfeit product, damaged item, seal broken, soiled, water or excess moisture within the package.

In one embodiment, to identify the abnormalities AI will match the weight of the item, if there is any difference in weight, there is an indication of missing sub items, and system identifies the sub-item based on the amount, weight is less which is equal to the at least one sub item weight, so it generates a missing part alert.

In one embodiment, AI module 140 will match the pre-stored x-rays images, with current x-ray image, if there is any difference in new pattern or sign appears in the new x-ray images, there AI module can identify the whether it within the threshold level or not and make decision, if not the AI module is adapted identified it as a damaged less which is equal to the at least one sub item weight, so it generates a missing part alert.

Similarly, other sensor inputs are mapped with the pre-stored input of the same type of sensors to find abnormalities. AI module 140 updates all the abnormalities in the learning database so that it can be used in the future for detecting the abnormalities.

At step 930, the system is adapted to check for any abnormalities in the abnormalities report.

If abnormalities are found at step 930, the method 900 moves to step 935 where it identifies the abnormalities identified related to the item and send alert to the concerned authority about the type of abnormalities along with time stamp.

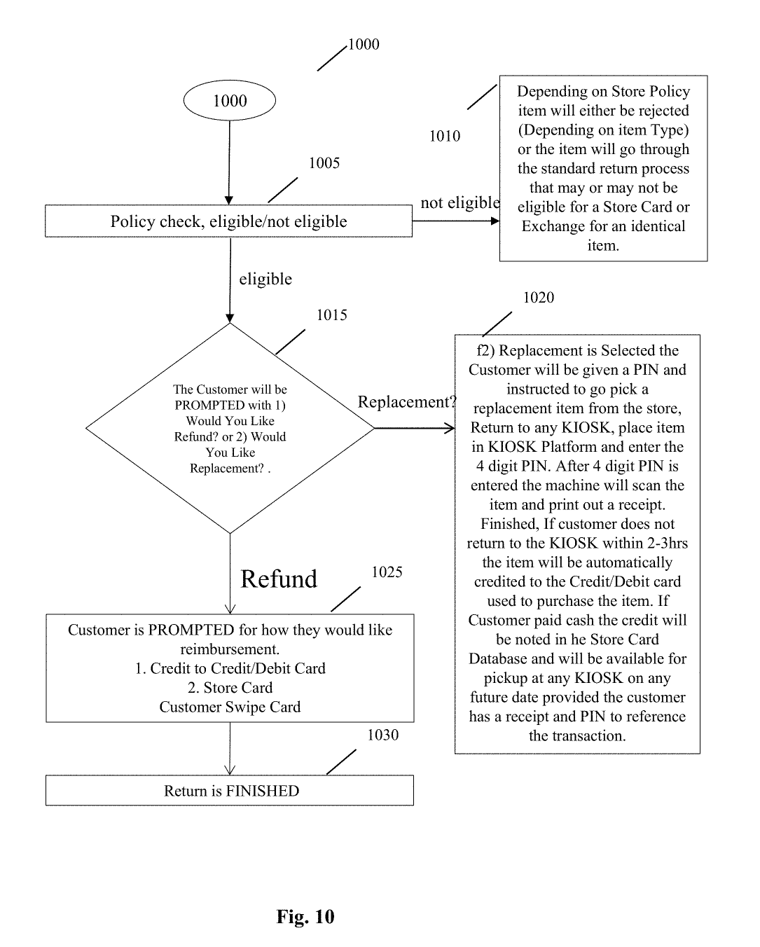

If the abnormalities are not found in step 930, the method 900 follows the steps 420-430 as described in FIG. 4. Thereafter the method 900 follows the step of method 1000 as shown in FIG. 10. After successful completion of the 420-430 as described in FIG. 4. The AI module is adapted to check the item policy and store policy and identify whether the return item is eligible or not eligible for return or exchange at step 1005. If the return item is eligible, The AI module is adapted to prompt the Customer. The customer will be PROMPTED with 1) Would You Like Refund? or 2) Would You Like Replacement? If the customer chooses refund option, at step 1015, the AI module is adapted to prompt the customer for how they would like reimbursement. 1. Credit to Credit/Debit Card 2. Store Card or customer swipe card. The AI module is adapted transfer the refund to at least one reimbursement option selected by the user at step 1025. The return process is finished at step 1030.

If the return item is found not eligible based on store and item policy, the AI module is adapted either be rejected (depending on item type or depending on store policy item) or the item will go through the standard return process that may or may not be eligible for a store card or exchange for an identical item, at step 1010.

If the user selected replacement option at step 1015, The AI module is adapted to provide a pin to the user or customer and instructed the user to go pick a replacement item from the store, return to any kiosk, place item in kiosk platform or receiving unit and enter the 4 digit pin via input device such as touch screen or enter the pin number in the mobile application. after the 4-digit pin is entered or received by the kiosk. The kiosk is adapted to scan the replacement item and print out a receipt and the replacement process is finished. In one embodiment, if the customer or user does not return to the kiosk within 2-3 hrs the item value or money will be automatically credited to the credit/debit card used to purchase the item. If the customer paid cash the credit is noted in the store card database and available for pickup at any kiosk on any future date provided the customer has a receipt and pin to reference the transaction, at step 1020.

The present invention is novel and inventive and has many advantages over the existing prior arts. The multifunction mobile holding apparatus as described herein above is simple, easy to implement and has multiple utilities. The said apparatus can be mounted on an external surface such as a laptop screen or the visor of a vehicle. The detachable and rotatable guiding units provide flexibility of use in any form. The sliding mechanism enables the adjustment of portable devices of any shape or size.

The terms “a,” “an,” “the” and similar referents used in the context of describing the invention (especially in the context of the following claims) are to be construed to cover both the singular and the plural unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

It is contemplated that numerical values, as well as other values that are recited herein, are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or another multiple of the actual value indicated, and/or described in the disclosure.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markus groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. The focus fidgeting tool is an appealing hands-on experience for anyone to enjoy. Our mission is to give access to therapeutic tools which motivate, engage, and assist individuals to become more independent and have a better quality of life

Although specific embodiments and certain structural arrangements have been illustrated and described herein, it will be clear to those skilled in the art that various other modifications and embodiments may be made incorporating the spirit and scope of the underlying inventive concepts and that the same is not limited to the particular methods and structure herein shown and described except insofar as determined by the scope of the appended claims.

What is claimed is:

1. A kiosk system adapted for purchase, return and exchange of at least one purchased item configured to initiate at least one process based on a user input in relation to one or more items, a self-operating networked kiosk comprising:
a touch screen for receiving at least one input from at least one user, one or more processor, a communication unit, at least one sensor, a distributed ledger and a memory unit in which a set of computer-executable instructions are stored;
the one or more processor coupled to at least one display unit having at least user interface, at least one input unit, the communication unit, the at least one sensor and the memory unit, wherein responsive to executing the instructions, the processor performs operations comprising:
receive an input from a user, via the at least user interface, wherein the input includes at least one action to be performed in relation to the item;
capture raw data related to the item via at least one sensor through a vision module and store the raw data in the memory unit;
an optical character recognition (OCR) engine configured to identify primary data from the raw data based on at least one predefined parameter and store the primary data in the memory unit;
an AI module configured to: retrieve the raw data and primary data from the memory unit;
generate a second fingerprint data based on the primary data and the at least one predefined parameter;
identify at least one first block having a first fingerprint data related to the item, wherein the first block is stored on a networked distributed ledger; and
create a second block including the first fingerprint data and the second fingerprint data at every change in custody of the item on the networked distributed ledger.

2. The self-operating networked kiosk as claimed in claim 1, wherein the kiosk further comprises a receptacle having a receiving area for receiving the item, wherein at least one sensor is attached to the receptacle, and wherein at least one robotic arm is attached to the receptacle for fixing the item at a desired position.

3. The self-operating networked kiosk as claimed in claim 1, wherein the at least one action in relation to the at least one item is selected from a group of an item return process, an item buying process, an item exchange and the combination thereof.

4. The self-operating networked kiosk as claimed in claim 1, wherein at least one input is an item return request, an item exchange request, an item buying request, a transaction request, a refund request and the combination thereof.

5. The self-operating networked kiosk as claimed in claim 1, further comprises receiving the at least one item at a receiving unit from the user when the user provides a return item request to at least one user interface.

6. The self-operating networked kiosk as claimed in claim 1, further comprises receiving at least one item at a receiving unit from an item inventory when the user provides a buying item request through at least one user interface, wherein the user is adapted to collect the at least one item at the receiving unit.

7. The self-operating networked kiosk as claimed in claim 1, further comprises receiving and transferring at least one item to a receiving unit from an automated inventory through an automatic product transfer system based on the input received from the user via at least one user interface, wherein the automatic product transfer system includes at least one conveyor belt system having a first end attached to the receiving unit and a second end attached to an automated inventory for transferring the at least one item to the receiving unit from the automated inventory and vice versa.

8. The self-operating networked kiosk as claimed in claim 1, further comprises the self-operating networked kiosk is communicably connected to at least mobile device and communicate to at least one mobile device via a wireless network through a block chain network within a closed and open environment.

9. The self-operating networked kiosk as claimed in claim 8, wherein the at least one mobile device is selected from a group comprising of a point of sale POS, a sales agent computing device, a smart phone, an automated inventory system, an automatic product transfer system, a warehouse management system, a second networked kiosk, a computer, a laptop, a cloud storage, a remote server, a blockchain, a distributed ledger and combination thereof.

10. The self-operating networked kiosk as claimed in claim 1, wherein the at least one sensor is selected from a group of high-resolution image sensor, motion sensor, a weight sensor, x-ray sensor, camera sensor, Temperature Sensor, Proximity Sensor, Accelerometer, IR Sensor (Infrared Sensor), Pressure Sensor, Light Sensor, Ultrasonic Sensor, Smoke, Gas and Alcohol Sensor, Touch Sensor, Color Sensor, Humidity sensor, Tilt Sensor, Flow and Level Sensor, Touch Sensor, barcode reader, RFID reader and the combination thereof.

11. The self-operating networked kiosk as claimed in claim 1, wherein the raw data captured by at least one sensor includes item images, x-ray images, metadata, barcode information, RFID code images, x-ray images, weight of the item or sub-items within a package, total weight of the item with or without packaging, printing pattern, text style, colored used on the text or colored used on the packaging, watermark information, packaging information, labelling information and special markings, item information such as UPC code, serial number, manufacturer name, and the combination thereof.

12. The self-operating networked kiosk as claimed in claim 1, wherein the self-operating networked kiosk further comprises identifying at least one abnormalities related to the item,
accepting and rejecting an item return request based on the at least one abnormalities related to the item.

13. The self-operating networked kiosk as claimed in claim 1, wherein the self-operating networked kiosk further comprises identifying at least one abnormalities related to the item,
accepting and rejecting the item purchasing request based on the at least one abnormalities related to the item.
